(19) United States
(12) Patent Application Publication
(10) Pub. No.: US 2010/0283636 A1
(43) Pub. Date: Nov. 11, 2010

(54) MULTI-FUNCTION SWITCHES FOR A DISPLAY

(75) Inventors: Samuel T. CLARK, Federal Way, WA (US); Roglenda R. BOWE, Maple Valley, WA (US)

Correspondence Address: The Boeing Company;c/o Sawyer Law Group, P.C., P.O. Box 51418, Palo Alto, CA, 94303, US

(73) Assignee: THE BOEING COMPANY, Chicago, IL (US)

(21) Appl. No.: 11/939,806

(22) Filed: Nov. 14, 2007

(51) Int. Cl. G01C 23/00

(52) U.S. Cl. 340/971

(57) ABSTRACT

Momentary multi-state/mode information switches, (e.g., all, some, or no information), and control switches (e.g., on, auto, off), are disclosed in accordance with an embodiment. In one implementation, ‘some’ information display involves intermediate ‘filtered’ or otherwise processed levels of information, that may dynamically change as a function of time, position, circumstance, or other logic. In addition, state or mode information may be selected manual or could be selected utilizing more sophisticated automatic state/mode changes. In a corresponding/similar implementation, ‘auto’ control involves the use/processing of ownship and traffic information that may dynamically change as a function of time, position, circumstance, or other logic. The benefits of such switches are increased functionality within the same switch space as a conventional on-off momentary pushbutton switch. The switches also support new types of situational awareness displays and aircraft system control in addition to allowing for the manual control of such displays and systems.

### FIELD OF THE INVENTION

This disclosure relates generally to displays and systems, and more particularly to methods and systems for utilizing one or more switches to control such displays or systems.

### BACKGROUND

At least some known aircraft include cockpit displays that are controlled by an information system. Cockpit displays include the basic displays that are supplied with the aircraft, and other add-on displays which vary in their degree of integration with the physical aircraft structure and aircraft systems. In addition, some known aircraft include displays which provide a ‘virtual’ display based interface through which the crew controls aircraft systems.

To promote safety and efficiency, electronic moving maps in general, and an electronic airport moving map (EAMM) in particular, may be provided on cockpit displays. The EAMM provides a map of the airport surface with an ownship position depiction, and may include cleared taxi route, and other operational information, for example, automatic terminal information service (ATIS)/notice to airmen (NOTAM) information, runway status, runway exit info, traffic, alerting, and other features. During taxi, takeoff, on approach and during landing/rollout, the EAMM may provide runway related information such as runway status and related traffic, traffic conflicts, braking, and runway exit information. However, manual crew display range control to view/display runway and related operational information may introduce new and undesirable crew workload. In addition, the discrete/fixed display range selections currently used do not allow optimum display of runway and other important and useful operational information.

Current implementations of navigation display and EAMM display range selection are typically in whole number increments for example, 640, 320, 160, 80, 40, 20, 10, 5, 2, 1, and 0.5 nautical mile ranges such that intermediate display range selections between the whole number increments are not utilized. Range selection may be defined by specific rotary switch positions, or an infinitely rotating switch may be used with the range selections coded in software. Further, the manual setting of the display range may preclude display of traffic, areas or other objects of interest, or other information within or beyond the display range of the EAMM that may be important to safety and/or situational awareness.

Different information shown on such displays are controlled by a plurality of push button switches that can be accessed by a pilot. Typically these are momentary two state on/off pushbutton information switches. These on/off switches are provided to allow the selective ‘on demand’ display of information, and to declutter the display of such information when it's not needed. These pushbutton switches typically display all or no information. Where multiple mode or state switching is required, multi-position rotary or toggle switches are used instead of the pushbutton switches. These multi-position rotary or toggle switches and their state labeling require more control panel or display space than pushbutton switches. In addition, the momentary pushbutton switches provide only two states, and display too much (all) information, or too little (no) information. An alternative is therefore desired that overcomes these switch space, state, and information limitations.

### SUMMARY OF THE INVENTION

A system and method for displaying information to a user is disclosed. The system and method comprises a module that processes data that determines a status of a specified area, receives identifying information about the specified area and provides a criteria by which at least three different states of the identifying information can be provided. The system and method also includes at least one momentary switch to provide a control signal to the module. The momentary switch cycles between the at least three different states of identifying information to allow for each of the states of the identifying information to be displayed via the display panel switch.

Momentary multi-state/mode switches, (e.g., all, some, or no information) are disclosed in accordance with an embodiment. In one implementation, ‘some’ information display involves intermediate ‘filtered’ or otherwise processed levels of information, that may dynamically change as a function of ownship or traffic related time, position, circumstance, or other logic. In addition, state or mode information may be selected manually or could be selected utilizing more sophisticated automatic state/mode changes enabled by the selected switch state. The benefits of such switches are increased functionality within the same switch space as a conventional on-off momentary pushbutton switch. The switches also support new types of situational awareness displays and aircraft system control in addition to allowing for the manual control of such displays and systems.

The features, functions, and advantages can be achieved independently in various embodiments of the present invention or may be combined in yet other embodiments.

### BRIEF DESCRIPTION OF DRAWINGS

FIG. 1 is a side elevational view of a vehicle such as an aircraft in accordance with an embodiment of the present disclosure.

FIG. 2 is a schematic data flow diagram of electronic airport moving map system (EAMM) for a vehicle in accordance with an embodiment of the disclosure.

FIG. 3 is a front perspective view of an exemplary electronic flight information system (EFIS) control panel that may be used with electronic airport moving map system (EAMM) shown in FIG. 1.

FIG. 4A-4C illustrates a multifunction hardkey (e.g., EFIS panel switch) control of information display.

FIG. 5A-5C illustrates a multifunction softkey (e.g., cursor or touch) control of information display.

FIG. 6A-6C illustrate all, some or none of traffic identifiers (TWID) during approach taxi.

FIG. 7A-7C illustrates all, some, and none traffic (TFC) on a display during approach/landing.

FIG. 8A-8C illustrates all, some, and none traffic (TFC) on a display during taxi.

### DETAILED DESCRIPTION OF PREFERRED EMBODIMENTS

This disclosure relates generally to displays and systems and more particularly, to methods and systems for utilizing one or more switches to control such displays or systems. The following description is presented to enable one of ordinary skill in the art to make and use the embodiment and is provided in the context of a patent application and its requirements. Various modifications to the preferred embodiments and the generic principles and features described herein will be readily apparent to those skilled in the art. Thus, the present embodiment is not intended to be limited to the embodiments shown, but is to be accorded the widest scope consistent with the principles and features described herein.

Accordingly, it is desired to provide more and new aircraft and operational information functionality while minimizing required switch space (numbers, size, etc). As more advanced situational awareness (SA) applications such as Airport Moving Map (AMM) with taxi route and runway status, Cockpit Display of Traffic Information (CDTI), Optimized Runway Exiting (ORE), and others are integrated onto the forward displays, the need for more sophisticated multifunction (multi-state or multi-modal) switches has arisen. Intermediate levels of information, often dynamically changing as a complex function of time, position, or circumstance, are needed to support the information awareness objective of SA displays. Accordingly, multi-function pushbutton switches which control multiple information states or display modes are disclosed.

Accordingly, multifunction pushbutton or virtual switches are provided which enable multi-state or multi-modal control or display of airport map, traffic, enroute map and other application related operational information or modes required to provide operational situational awareness. These multi-function switches allow multiple displays/information state or mode selections while minimizing required panel or display space. Such multi-function switches may be dedicated pushbutton hardware switches or virtual display based “softkeys” or switches.

Momentary multi-state/mode switches provide for all, some, or no information display. Where ‘some’ information display involves intermediate ‘filtered’ or otherwise processed levels of information, that may dynamically change as a function of time, position, circumstance, or other logic. In addition, the selected information state or mode may be manual or could involve more sophisticated automatic state/mode changes. The benefits of such switches are increased functionality within the same switch space as current, reduced/minimized switch number and space requirements, optimized information display, and support of new situation awareness displays and system controls. In addition to manual control, such switches enable more sophisticated automatic state/mode changes.

To describe the embodiments of the present invention in more detail refer now to the following description in conjunction with the accompanying figures.

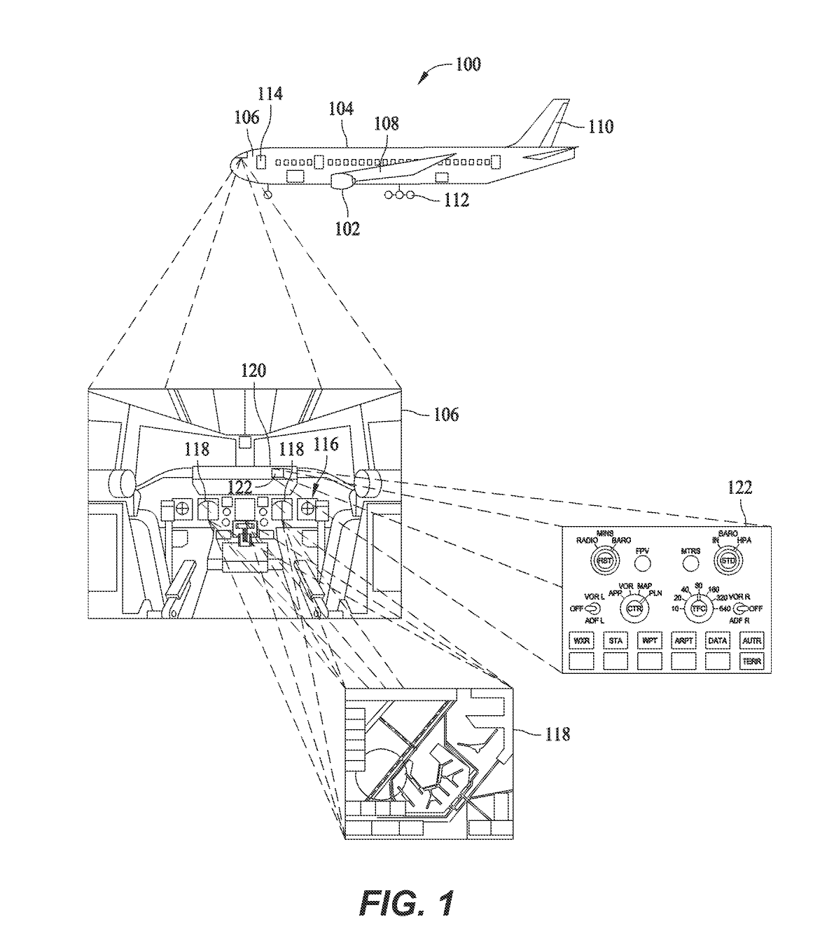

FIG. 1 is a side elevational view of a vehicle 100 such as an aircraft in accordance with an embodiment of the present disclosure. Aircraft 100 includes one or more propulsion engines 102 coupled to a fuselage 104, a cockpit 106 in fuselage 104, wing assemblies 108, a tail assembly 110, a landing assembly 112, a control system (not visible), and a plurality of other systems and subsystems that enable proper operation of vehicle 100. At least one component of an electronic airport moving map system (EAMM) 114, formed in accordance with the present disclosure, is located within fuselage 104. However, components of EAMM system 114 may be distributed throughout the various portions, systems and subsystems of vehicle 100 and other components may also be located off board vehicle 100 and in communication with the onboard components.

Although vehicle 100 shown in FIG. 1 is generally representative of a commercial passenger aircraft, the inventive apparatus and methods disclosed herein may also be employed in virtually any other types of aircraft, other vehicle, or fixed base control station. More specifically, embodiments of the present disclosure may be applied to other passenger aircraft, cargo aircraft, rotary aircraft, and any other types of aircraft. It may also be appreciated that alternate embodiments of the system and methods in accordance with the present disclosure may be utilized in a wide variety of vehicles, including, ships, trains, and any other suitable vehicle. It may also be appreciated that alternative embodiments of the system and methods in accordance with the present disclosure may be utilized in a wide variety of fixed base and/or non-moving applications such as air traffic control towers, radar control and monitoring stations, and other complex system control and monitoring stations—e.g., electrical power generation and distribution systems.

Cockpit 106 includes an aircraft cockpit display panel 116 that includes at least one display screen 118 in accordance with an embodiment of the present disclosure. In the exemplary embodiment, display screen 118 is positioned on the aircraft cockpit forward display panel 116. In an alternative embodiment, display screen 118 is positioned on an auxiliary side, overhead panel, or forward head-up display (not shown) located in the cockpit of the aircraft. During aircraft operation, display screen 118 is available for viewing by a pilot, co-pilot, and/or other flight deck occupant of the aircraft. Display screen 118 may be used to view data included in an electronic flight bag (not shown), which may be embodied as a standalone device such as, but not limited to a PDA or laptop PC, or as a software component of a system executing on a processor that is part of a subsystem of the aircraft. In the exemplary embodiment, an electronic flight bag or navigation display includes an electronic storage device configured to store various user-configurable flight-related objects for all required and desired information to display an aircraft's own position, runway status as well as map, traffic, and other information relevant to the movement of ownship aircraft. Data is received from various aircraft and ground sensors and systems. Route, traffic, runway, approach, and departure information based on the received data is determined in real-time, and the route, traffic, runway, approach, and departure information and/or alerts are displayed to the flight crew through display screen 118 and other cockpit 106 aurals and/or visual indicators. Such runway, approach, and departure information provides the flight crew with additional situational awareness during aircraft operation. Cockpit displays include the basic displays that are supplied with the aircraft, and other add-on displays which vary in their degree of integration with the physical aircraft structure and aircraft systems.

Cockpit 106 also includes a glare shield 120 that includes at least one EFIS control panel 122 that is used to control a respective Primary Flight Display (PFD) and/or Navigation Display (ND). EFIS control panel 122 includes controls for selecting autorange, various ND modes and ranges as well as switches which control the display of traffic and other information.

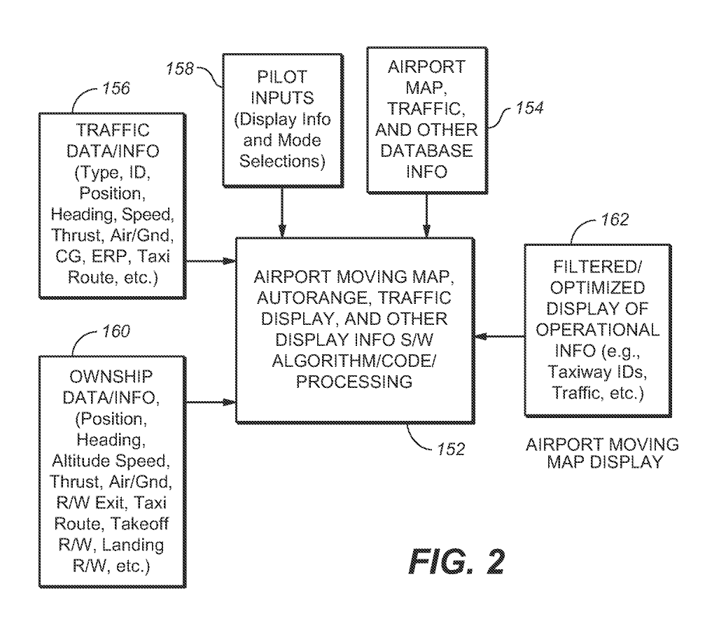

FIG. 2 is a schematic data flow diagram of electronic airport moving map system (EAMM) 114, for a vehicle in accordance with an embodiment of the disclosure. In this embodiment, an airport moving map module 152 of system 114 receives airport map data information 154, traffic data/information 156, pilot inputs 158, and ownship data/information 160 from respective modules and/or vehicle subsystems. Airport moving map module 152 then processes the collective data to define and activate the display of an optimized range for a graphic display 162 that includes a volume about one or more areas or items of interest, for example, but not limited to an airport. Airport moving map module 152 also monitors other vehicle positions and movements as well as the position of stationary objects proximate the area of interest for display on an airport moving map display 162.

In the exemplary embodiment, traffic data/information 156 and ownship data/information 160 may be obtained, for example, from automatic dependent surveillance broadcast (ADS-B) traffic information, air traffic control (ATC) radar traffic information, ground vehicle traffic information, and aircraft system and aircraft database information. Based on EFIS panel pilot inputs and other inputs, airport moving map module 152 controls the manual and automatic display of such traffic information.

Traffic data/information 156 includes data regarding the type, identification, position, speed, thrust, and taxi route of one or more vehicles, as well as data as to whether each vehicle is on the ground or airborne. In particular, due to the large dimensions of some traffic vehicles, e.g., commercial passenger aircraft, the position of each traffic vehicle may be further defined as the operator eye reference point (ERP) in each vehicle. In other words, the position of a traffic vehicle may be further pinpointed as the position within the vehicle occupied by the operator. In alternative embodiments, the position of a traffic vehicle may also be further defined as the vehicle's center of gravity (CG). For example, for a traffic vehicle that is an aircraft, the position of a traffic vehicle may be further pinpointed to the approximate longitudinal and bilateral center of the aircraft's fuselage or wing. Nevertheless, it will be appreciated that the position of a traffic vehicle may also be defined in alternative ways, such as by an imaginary envelope encompassing the most distal point or points of the traffic vehicle. The position of such traffic is a prerequisite to the display or filtering of such traffic.

Ownship data/information 160 includes data regarding the type, identification, position, heading, speed, thrust, taxi route, as well as data as to whether the aircraft is on ground or airborne. Again, the position of ownship, or an aircraft equipped with EAMM 114, may be defined as the operator (pilot) eye reference point (ERP), as well as the aircraft's center of gravity (CG), or other suitable alternatives, such as by an imaginary envelope encompassing the most distal point or points of the aircraft. One or more of ownship data/information and EFIS control panel information switch states are a prerequisite to the display or filtering of such information as runway status, taxiway identifiers, and traffic. Furthermore, (EAMM) 114 may use determinations of runway status together with ownship data/information and EFIS control panel autorange switch state to determine autorange activation and range selection. Runway status may determine whether a runway is one of Unoccupied, Occupied, In-Use (meaning use by an ownship may be limited), Not-in-Use (meaning available for use by an ownship), or Restricted (meaning not available for use by an ownship). With respect to runway status indicators, “use by an ownship” or traffic vehicle refers to such operations as runway crossing, runway taxi, takeoff or approach, landing, and rollout.

In general, automatic information display and range control module 152 determines runway status for each runway based on one or more of traffic vehicle positions, ownship position, traffic and ownship headings, speed, time and distance separations, other logical conditions, and a monitored volume defined around each area of interest runway or other vehicle path. Information for defining a monitored volume with respect to each runway may be supplied by Airport Map Database 154. In one embodiment, the three dimensional monitored volume is established with respect to the length of the runway, the width of the runway, and a predetermined height above the runway. In a further embodiment, the monitored volume dimensions extend a predetermined distance to the left and right of runway centerline, extend a predetermined distance beyond each runway threshold, and extend to a predetermined height above ground level. In an additional embodiment, the dimensions and the shape of the monitored volume may be varied as a function of estimated, calculated or required time of traffic or ownship arrival to the runway corresponding to the monitored volume. Nevertheless, it will be appreciated that the dimensions and the shape of the monitored volume may also be varied to support effective implementation, such as to accommodate operational needs, unusual or non-linear airport runway, taxiway, approach and departure path configurations, as well as for other applications such as traffic display/filtering and traffic conflict alerting. Automatic information display and range control module 152 utilizes runway status, traffic and ownship data/information, and EFIS control panel information switch states to determine the display or filtering of map information such as runway status, taxiway identifiers, and traffic, and to control the activation and behavior of such functions as autorange.

Moreover, a plurality of logic algorithms and parameters may be used to determine runway status, automatic range selection, and off scale range selection. Runway status may be a necessary, but not always sufficient component, for offscale traffic autorange and other functions, for example an automatic range selection or a traffic conflict alert, or for the display of traffic, offscale traffic indications, and other map information. In addition, runway status may be used to support autorange or traffic conflict alerting but not displayed. For example, an occupied runway may be an area of interest for automatic range selection. If the runway meets the criteria for an occupied status, a vehicle may be in a position to present an actual or potential threat or conflict with ownship.

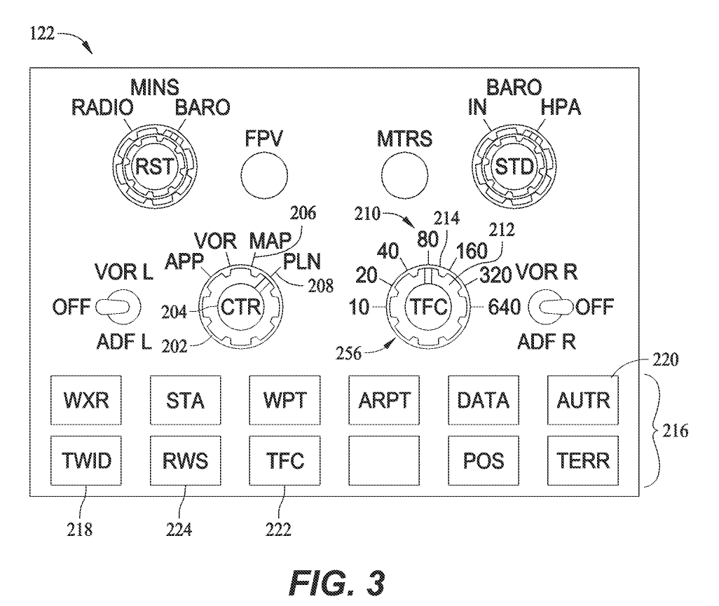

FIG. 3 is a front perspective view of an exemplary EFIS control panel 122 that may be used with electronic airport moving map system (EAMM) 114 (shown in FIG. 1). The control panel includes a plurality of momentary push button switches that can be utilized to control the activation of functions and the display of information on EAMM 114. EFIS control panel 122 includes an ND Mode Selector 202 for selecting a track up or a north up map display orientation and a CTR Switch 204 for selecting centered or expanded mode map display. CTR Switch (inner) 204 when pushed, centers the display on ownship and displays full compass rose. Subsequent pushes alternate between expanded and centered displays. ND Mode Selector (outer) 202 includes a MAP position 206 for selecting track up map orientation, and a PLN position 208 for selecting North up map orientation. MAP position 206 provides FMC-generated route and map information, airplane position, heading and track displayed in track-up format. PLN position 208 provides a stationary north-up map depiction. In all modes, the airplane symbol represents the ownship position and orientation.

EFIS control panel 122 further includes an ND Range Selector and TFC Switch 256 that includes a TFC Switch (inner) 212 that when pushed, displays TCAS (traffic collision and avoidance system) traffic information on the ND and a ND Range Selector (outer) 214 that is used to manually select the desired ND nautical mile range scale.

A plurality of MAP switches 216 select or remove detailed ND information. More than one MAP switches 216 may be selected at a time. In the exemplary embodiment, a taxiway identifier (TWID) switch 218 is a three state pushbutton switch that is selectable to cycle through positions that display all, some, and no taxiway identifiers in turn. Taxiway identifiers are used to display a status of each taxiway, such as the taxiways being available for use and/or a taxiway nomenclature that uniquely identifies the taxiway. As TWID switch 218 is repeatedly depressed the switch state changes with each depression and more or less information is displayed to the flight deck crew. When the ‘all’ switch state for taxiway identifiers is selected, all identifiers on the taxiways will be displayed. When the ‘some’ switch state for taxiway identifiers is selected only those identifiers for the currently displayed taxi route and/or those identifiers determined to be relevant to ownship position, orientation, or operations are displayed. When the ‘no’ switch state for taxiway identifiers is selected, taxiway identifiers indication is turned off. Other airport map identifiers such as concourse and gate identifiers may be controlled by TWID switch state, and/or controlled by a separate concourse and gate identifier switch. In an alternative embodiment of this and other such information and control switches, four or more switch states may be used.

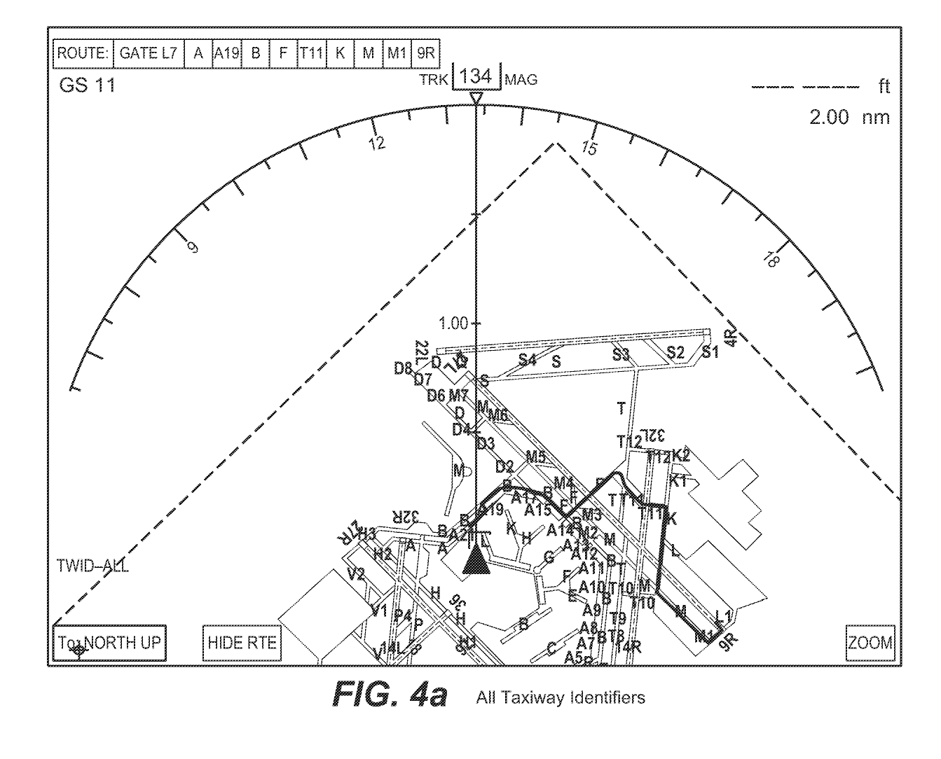

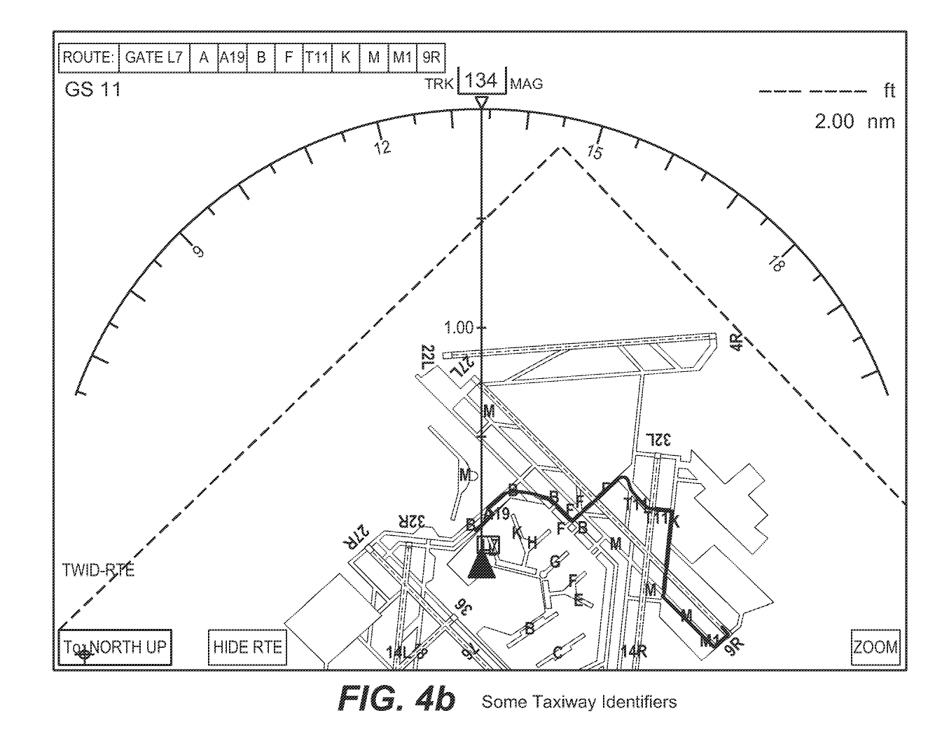

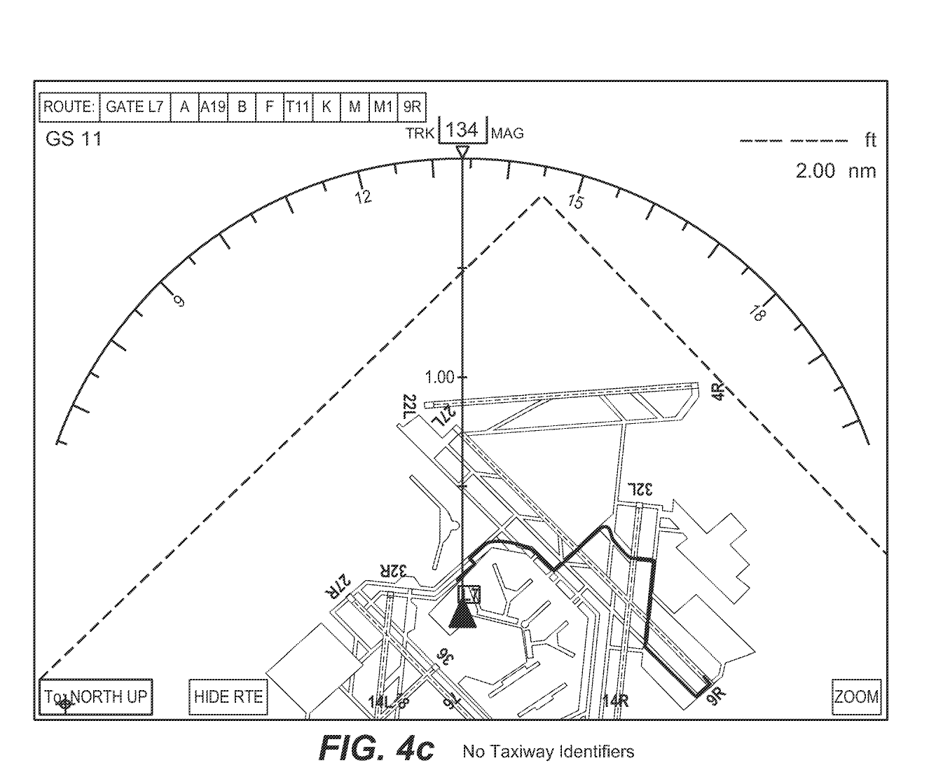

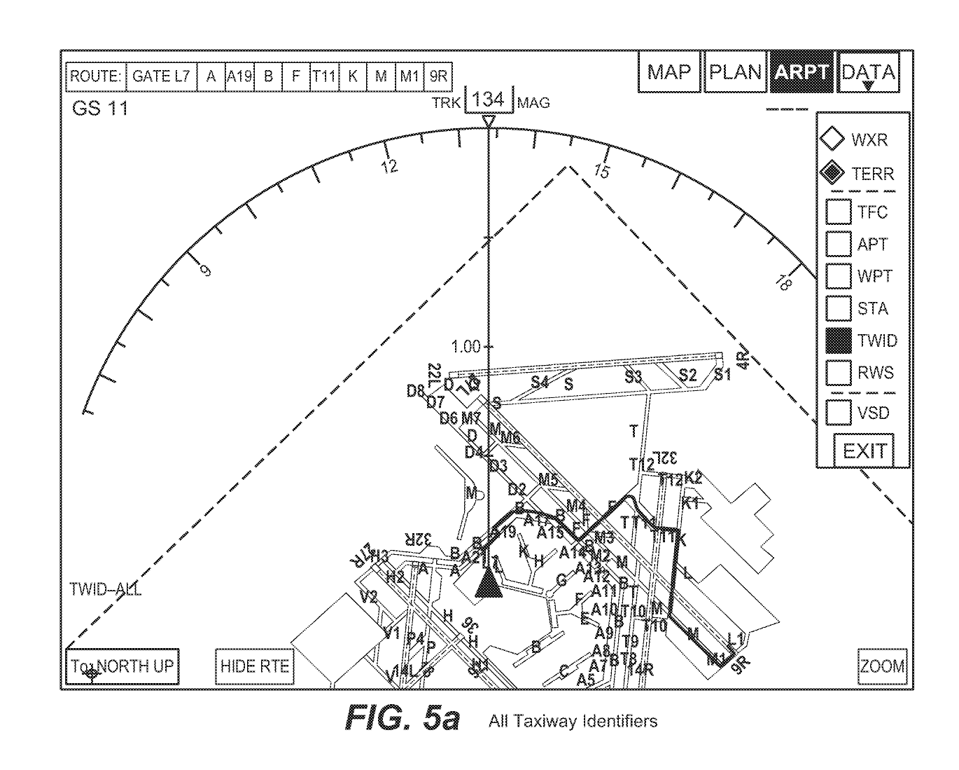

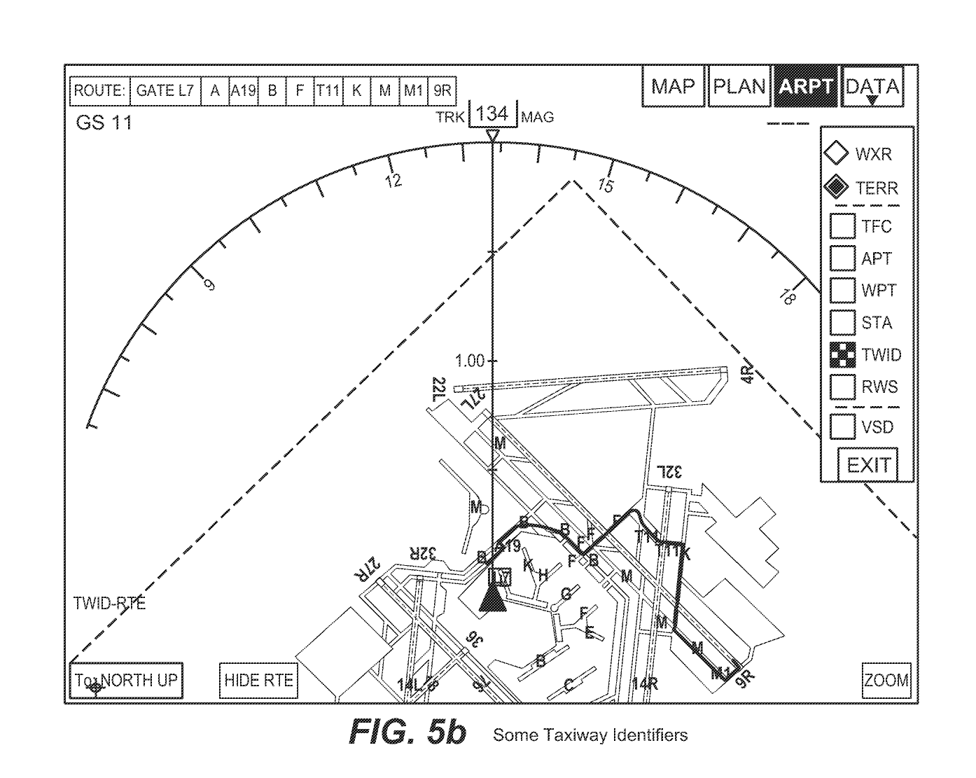

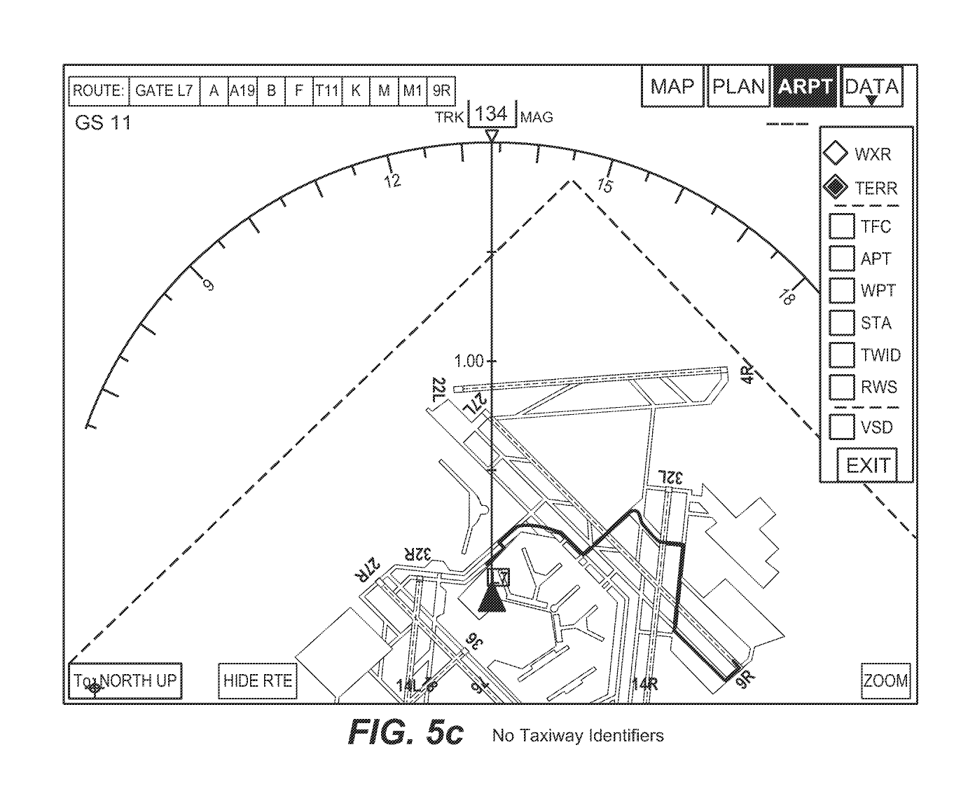

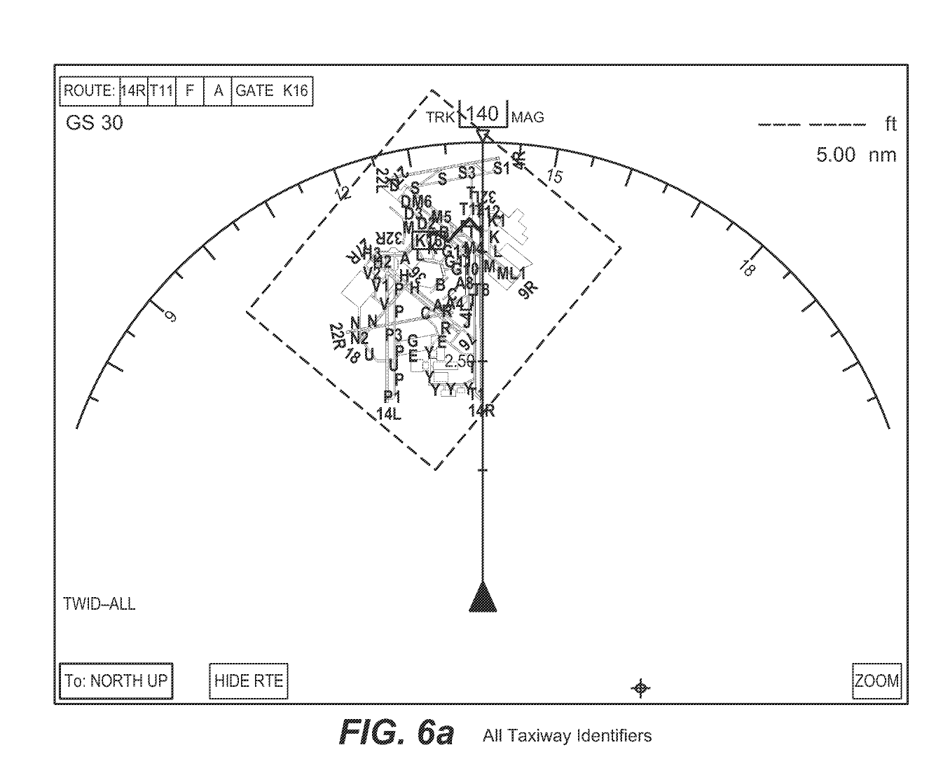

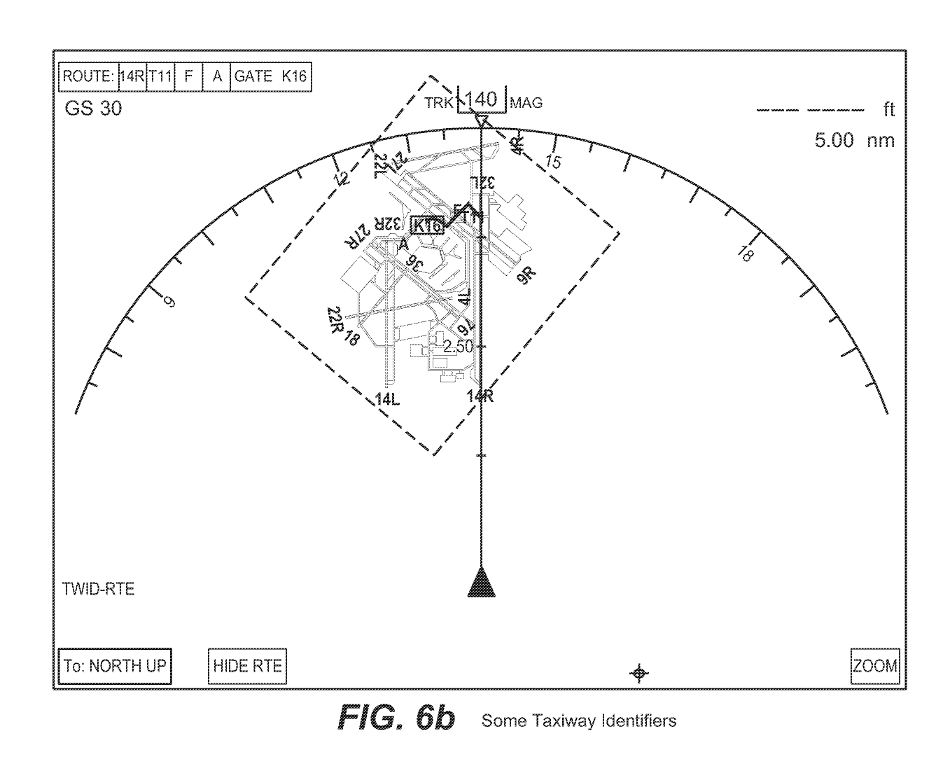

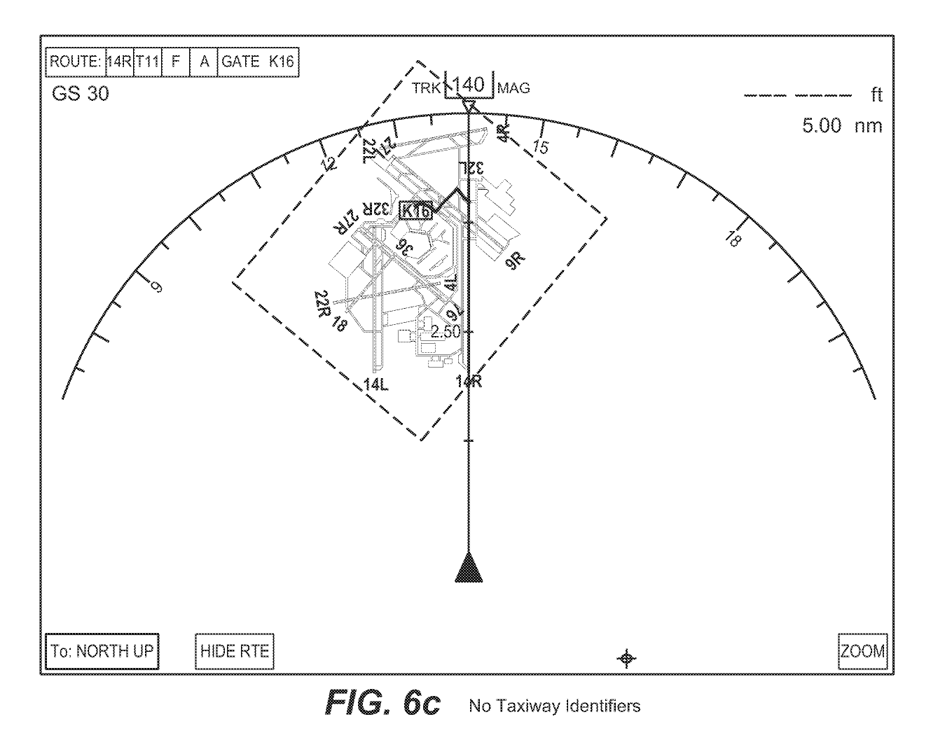

FIGS. 4A-4C, 5A-5C, and 6A-6C illustrate All-Some-None taxiway identifier (TWID) switch states. FIG. 4A-4C illustrates a multifunction hardkey (e.g. EFIS panel switch) control of information display for the TWO switch state. FIG. 4A illustrates all traffic identifiers. FIG. 4B illustrates some traffic identifiers. FIG. 40 illustrates no traffic identifiers. Note that alternatively, none could also inhibit the graphical and/or alphanumeric display of taxi route. FIGS. 5A-5C illustrate a multifunction softkey (e.g., controlled by cursor or touch) control of information display for the TWID switch state. FIG. 5A illustrates all taxiway identifiers. FIG. 5B illustrates some taxiway identifiers. FIG. 5C illustrates no taxiway identifiers. Shape and color coding of the TWID softkey switch is used to indicate all, some, or no taxiway identifiers selected for display. Note again, that alternatively, none could also inhibit the graphical and/or alphanumeric display of taxi route. FIGS. 6A-6C illustrate all, some or none of taxiway identifiers (TWID) display during approach taxi. FIG. 6A illustrates all taxiway identifiers. FIG. 6B illustrates some taxiway identifiers. FIG. 60 illustrates no taxiway identifiers.

In one embodiment an AutoRange (ARNG) switch 220 toggles between auto-range on (enabled) and off (disabled). ARNG switch 220 enables automatic range display and permits activation of approach autoranging logic, traffic autoranging logic, and other (area or object) autoranging logic. The autoranging logic may be based on threats and conflicts or potential threats and conflicts between ownship and other vehicles, objects, and/or areas of interest, or used to determine and control to the optimal range for display of operationally useful information such as landing runway, runway exit, and other objects or areas of interest. For example, during approach and landing, autoranging to maintain one or more of the approach runway or obstacles proximate the airport, traffic in the air or proximate the runway displayed for the flight crew at the optimal range setting facilitates improving situational awareness while reducing flight crew workload. The autorange display of information, potential threats/conflicts, or threats/conflicts may be prioritized to ensure appropriate crew awareness. While taxiing, autoranging logic monitors and displays other taxiing, take-off, and landing traffic to determine threats and conflicts or potential threats and conflicts between ownship and the traffic to facilitate situational awareness and safety on the ground. In addition, autorange may optimize the display of taxiway intersections where a route turn occurs, runway crossings, or runway intersections.

When ARNG switch 220 is selected off (disabled), the cockpit display uses (reverts to) the manually selected range for display. Moreover, when autorange logic deactivates, the cockpit display will also use (revert to) the manually selected range for display. During operation, when there are no offscale threats and conflicts or potential threats and conflicts between ownship and the traffic, or no operationally important offscale information, the autorange logic will deactivate and return the display autorange setting to the manually selected display range setting. In a preferred embodiment, ARNG switch 220 toggles between three states: auto-range on (enabled), Reset (returned to manually selected display range but reenabled for a new condition) and off (disabled). Once autorange activates, selecting the switch would reset (deactivate) autorange and enable it for activation/operation once new logical conditions for autorange activation were satisfied. With autorange on or activated, selecting the switch twice within some specified period of time (e.g., <1 or 2 seconds) or depressing the switch continuously for some specified period of time (e.g., >2 or 3 seconds) could turn autorange off (disable autorange until manually reselected on). In an alternative embodiment an approach AutoRange (ARNG) switch 220 toggles between three states: on (enabled) to display end of runway on approach, on (enabled) to display runway exit on approach, and off (disabled).

These states could be implemented using two switches—one for On/Off and one for Reset, or could be implemented in a single multi-function momentary push button or softkey switch. In the single switch implementation, the autorange control states would be ordered On (enabled), Reset (manually deactivated), and Off (disabled). From the Off state, selecting the switch would turn autorange on and enable it for activation and operation once the logical conditions for autorange activation were satisfied. Once autorange activated, selecting the switch would reset (deactivate) autorange, return the display to the previously selected manual range, and enable autorange for activation/operation once new logical conditions for autorange activation were satisfied. This allows the crew/user to recover to the manually selected display range without disabling autorange—in effect the user ‘acknowledges’ the information and the display is reset until some new condition requiring crew awareness occurs. As with other such multi-function switches, selected autorange state would either be intuitively obvious from the display or would be explicitly annunciated.

A traffic (TFC) switch 212 may be embodied in a three state pushbutton switch 222 that is selectable to cycle through states that display all, some, and no traffic depictions in turn. Traffic depictions may be used to display one or more of ground and/or airborne traffic that is taxiing, approaching a runway, on a runway, departing a runway, or landing and rolling out on a runway. As TFC switch 222 is depressed, more or less traffic information is displayed to the flight deck crew. When the ‘all’ switch state for traffic is selected, all traffic will be displayed. When the ‘some’ switch state for traffic is selected only that traffic that is determined to be relevant to ownship operation (e.g., related to current ownship position and orientation and/or associated with certain selected runways and/or taxiways and/or a potential or actual conflict with ownship) is displayed. Other traffic may also be displayed based on predetermined logic and/or selectable parameters. When the ‘no’ switch state for traffic is selected, all traffic indication is turned off with the possible exception of alert related traffic that is in actual or impending conflict with ownship, or is selected or otherwise designated for special operations. Traffic that is offscale and is determined to be a threat or conflict or potential threat or conflict with ownship activates autorange and is displayed, or activates an offscale indication of said traffic.

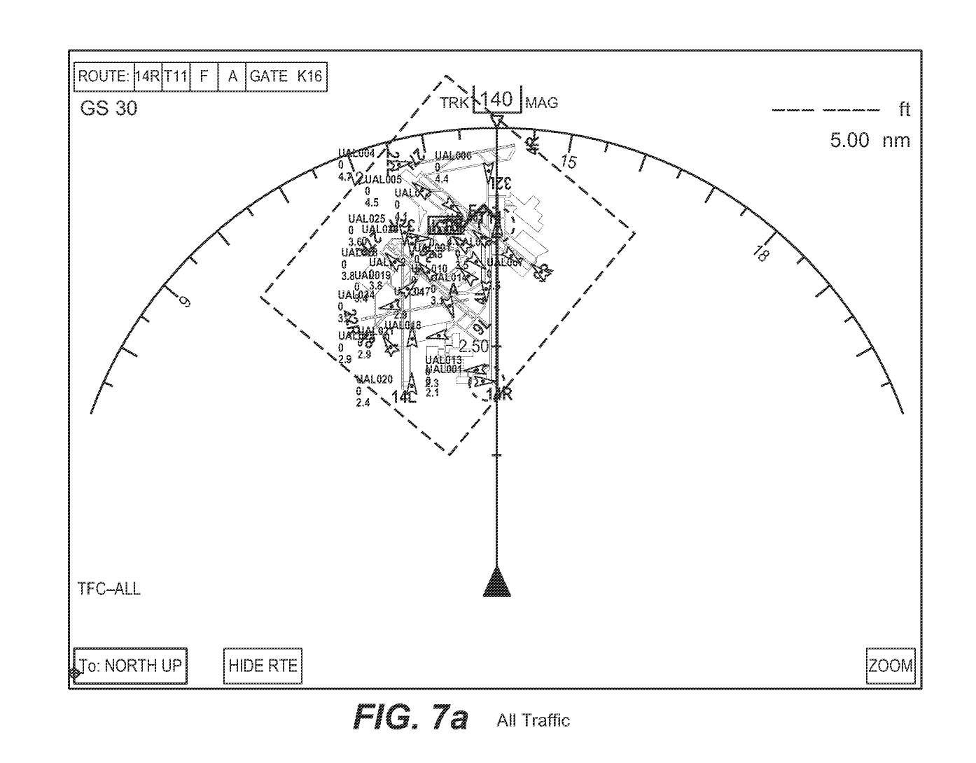

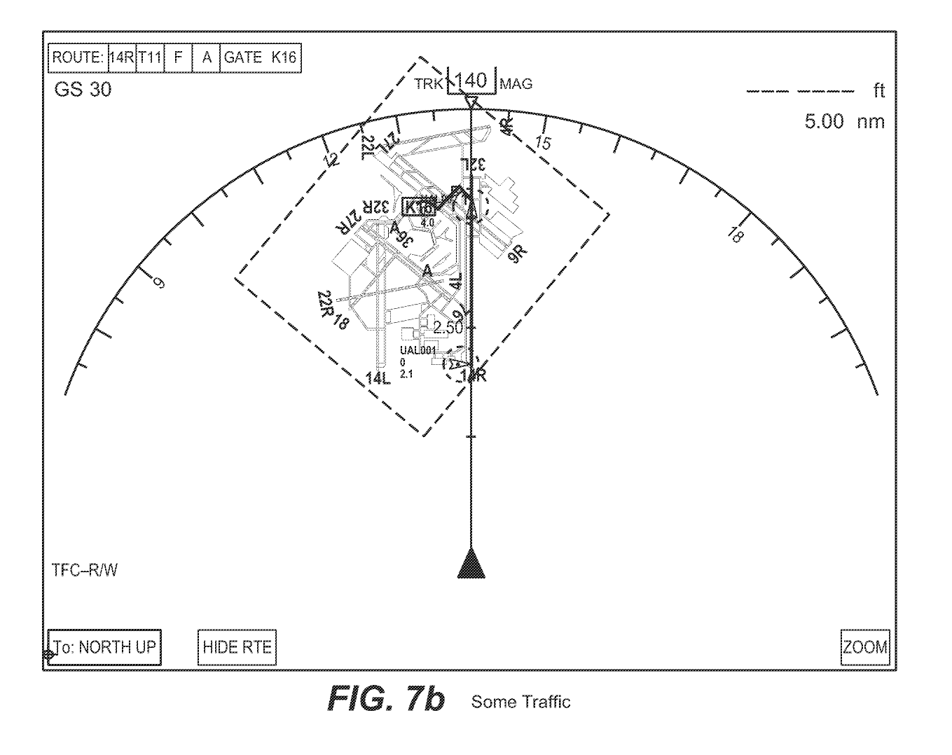

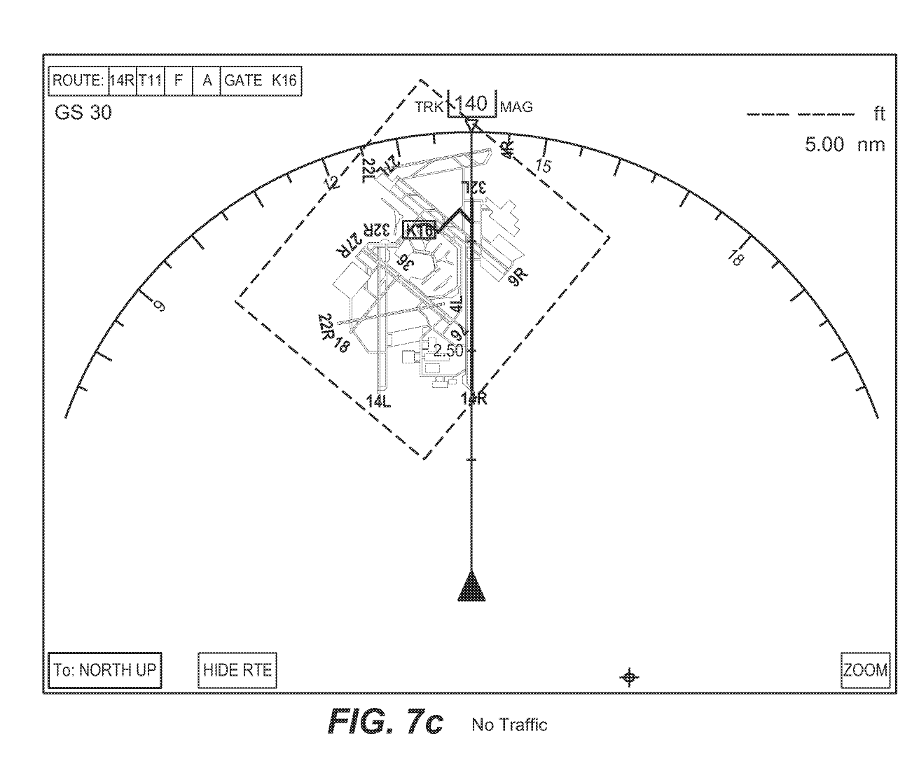

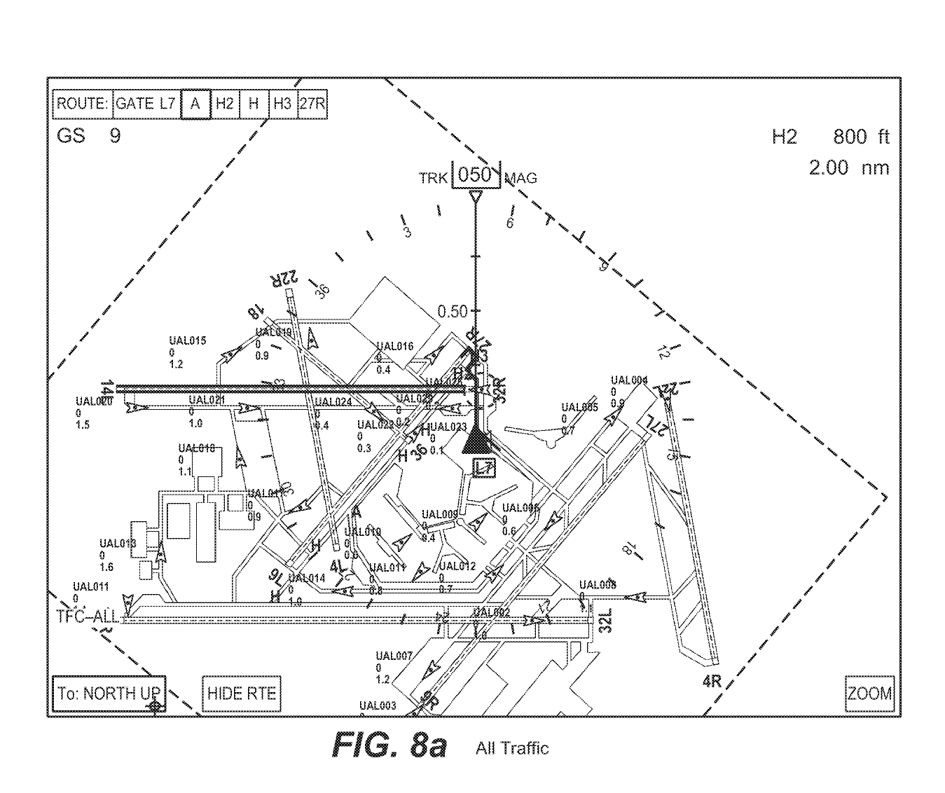

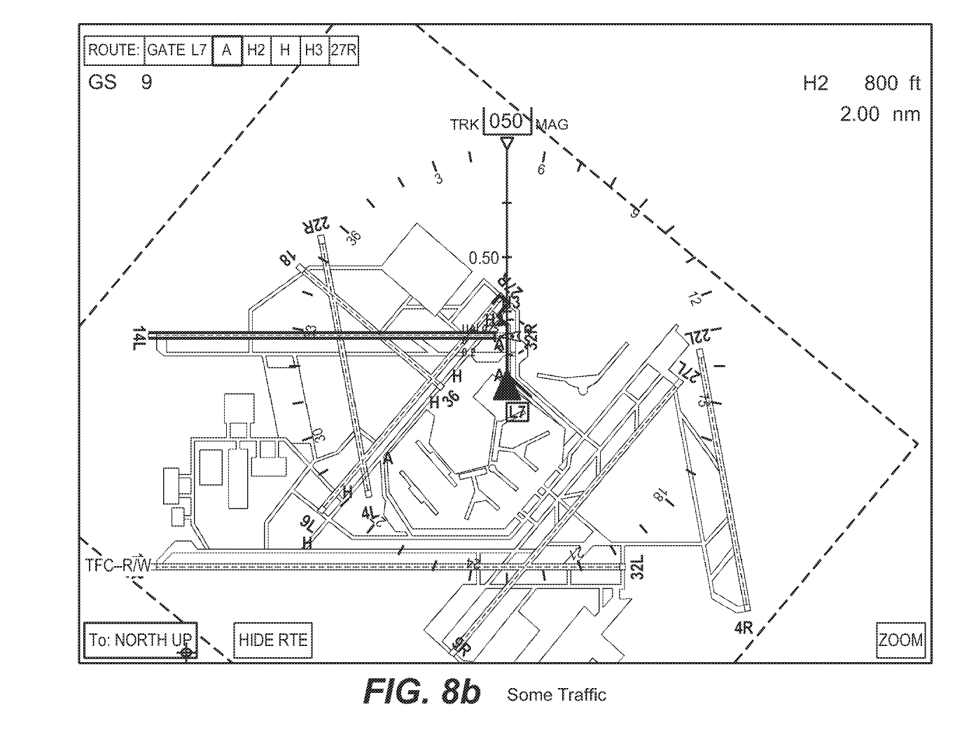

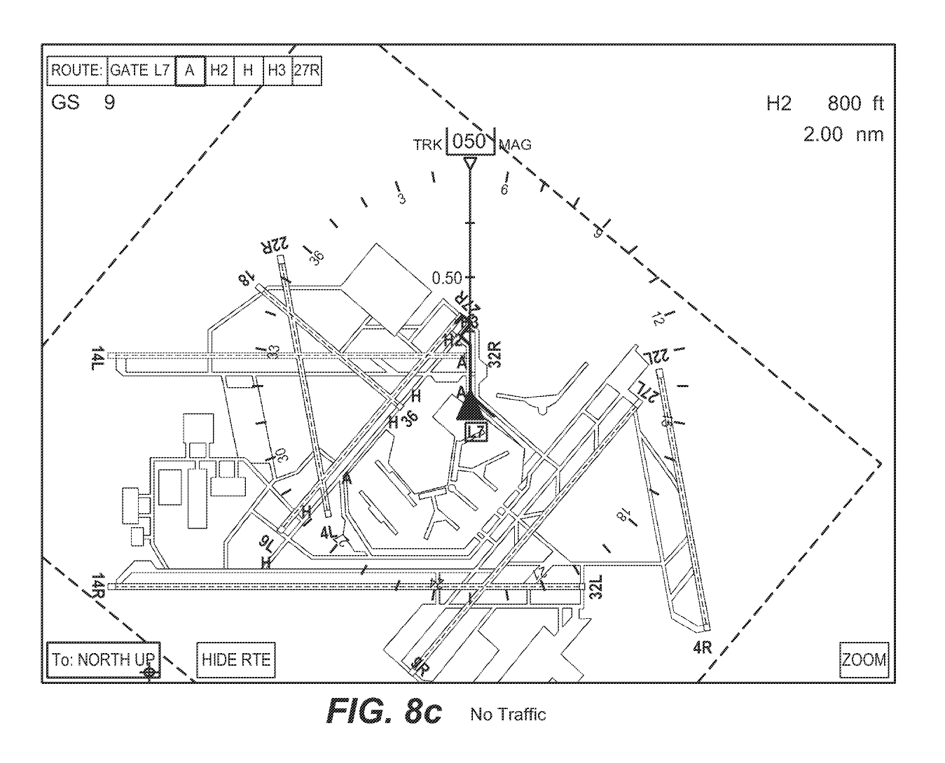

As shown in FIGS. 7A-7C and 8A-8C, switch information state may be included/shown on the display—e.g., TFC ALL (when all is selected), TFC R/W (when some is selected and represents only runway traffic), and no indication when no information is selected for display. FIG. 7A shows all traffic during approach/landing. FIG. 7B shows some traffic during approach/landing. FIG. 70 shows no traffic during approach/landing. FIG. 8A shows all traffic during taxi. FIG. 8B shows some traffic during taxi. FIG. 8C shows no traffic during taxi. The implementation of switch state display indications may take various other forms—the intent being to ensure user awareness of switch state and display information.

Referring back to FIG. 3, Runway Status (RWS) switch 224 can also be an All-Some-None multi-function information switch. ‘Some’ is the state of only those runways most relevant to current ownship position and phase of flight (r/w ownship is on/crossing, next r/w crossing, takeoff or landing r/w and intersecting runways with traffic converging on ownship). An RWS switch 224 may toggle between a runway status on and a runway status off position, or may be embodied in a three state pushbutton switch 222 that is selectable to cycle through states that in turn display all, some, and no runway status. As RWS switch 224 is depressed, more or less runway status information is displayed to the flight deck crew. When the ‘all’ switch state for runway status is selected, the status of all runways will be displayed. When the ‘some’ switch state for runway status is selected only the status for runways determined to be relevant to ownship operation (e.g., related to current ownship position and orientation and/or associated with certain selected runways and/or taxiways and/or a potential or actual conflict with ownship) is displayed. Other runway status may also be displayed based on predetermined logic and/or selectable parameters. When the ‘no’ switch state for runway status is selected, all runway status indication is turned off with the possible exception of alert related status associated with traffic that is in actual or impending conflict with ownship. In an alternative embodiment, the display and filtering (all-some-none) of traffic and runway status may be integrated into a single multi-fuction multi-state switch.

Traffic identification (TFID), or existing switches such as DATA 225, can also be implemented as All-Some-None multifunction information switches. In the case of traffic identification, identification for All traffic would be shown, identification for No traffic would be shown, or identification for Some (a subset) traffic would be shown based on some predetermined subset or logical conditions (e.g., runway only, runway status only, air only, ground only). Similarly, a multifunction information switch could be implemented for a group of traffic data (groundspeed, altitude, distance from ownship, etc), or combined with traffic identification [ID] switch control. In an alternative All-Some-None multifunction switch embodiment of traffic data, traffic data could be shown for all traffic. In this embodiment All would display all data for all traffic, Some would display a predetermined subset of data for all traffic, and None would display no traffic data. Regardless of the embodiment, when the ‘no’ switch state for traffic identification or data is selected, all traffic identification or data is turned off with the possible exception of alert related traffic that is in actual or impending conflict with ownship, or is selected or otherwise designated for special operations.

When ND MAP mode (206) is selected, a multiple-mode switch (CTR) switch 204 could be implemented to toggle between expanded, other and center modes. In this embodiment, ‘other’ is an alternative display mode format such as an Expanded Aft view (as opposed to the Expanded Fwd view currently provided), thus the CTR switch would toggle through three modes—expanded forward (ownship at bottom of display), center (ownship at center of display), expanded aft (ownship at top of display). Air-Ground logic could be used to enable the expanded aft mode only on ground.

A similar multiple-mode switch could be implemented for the North-Up (PLN) switch 208. The switch 208 would toggle through multiple display orientations—e.g., North-Up, Runway Up, and Runway Up Centered where the runway used is a user specified runway or the currently selected FMC departure or arrival runway.

A multi-function MAP switch (nor shown) may be implemented to control the display of multiple map formats. For example nav map only, airport map only, and nav plus airport maps.

Accordingly, multi-function pushbutton or virtual switches are provided which enable multi-state or multi-modal display of airport map, traffic, enroute map and other operational information or modes which provide operational situational awareness. These multi-function switches allow multiple displays/information state or mode selections while minimizing required panel or display space. Such multi-function switches may be dedicated pushbutton hardware switches or virtual display based “softkeys” or switches.

Momentary multi-state/mode switches, (e.g., all, some, or no information) are disclosed in accordance with an embodiment. In one implementation, ‘some’ information display involves intermediate ‘filtered’ or otherwise processed levels of information, that may dynamically change as a function of time, position, circumstance, or other logic. In addition, state or mode information may be selected manual or could be selected utilizing more sophisticated automatic state/mode changes. The benefits of such switches are increased functionality within same switch space as a conventional on-off momentary pushbutton switch, reduced/minimized switch number and space requirements, more sophisticated automatic state/mode changes, reduced crew workload, optimized information display, and increased crew situational awareness. The switches also support new types of situational awareness displays in addition to allowing for the manual control of such displays.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims

What is claimed is:

1. A system for displaying information comprising:
a display panel capable of displaying images to a user;
a module that processes data that determines a status of a specified area, receives identifying information about the specified area and provides a criteria by which at least three different states of the identifying information can be provided; and
at least one momentary switch to provide a control signal to the module, wherein the momentary switch cycles between the at least three different states of identifying information to allow for each of the states of the identifying information to be displayed via the display panel.

2. The system of claim 1, wherein the three different states comprise all, some or none, where some is an intermediate state between all and none.

3. The system of claim 1, wherein the three different states comprise at least one of (on, reset and off), or (on, auto and off).

4. The system of claim 1, wherein the at least one momentary switch unit comprises a plurality of momentary switches.

5. The system of claim 4, wherein the plurality of momentary switches comprise any and any combination of a taxiway identifier switch, a map switch, a map orientation switch, a traffic switch, a traffic information switch, an autorange switch, a runway status switch, a taxi route switch, an airport operational information switch, and a multiple display mode switch.

6. The system of claim 1, wherein the three different states comprise three alternative mode states.

7. The system of claim 1, wherein the three alternative mode states comprise North-Up, Runway-Up, and Runway-Up Centered.

8. The system of claim 5, wherein the switches function differently on-ground than when in flight, or in different ground or flight phases.

9. A system for displaying information comprising:
a cockpit display panel capable of displaying images of an airport to a flight crew member;
an airport moving map module that processes data that determines airport specific information, receives identifying information about the airport specific information and provides a criteria by which at least three different states of the identifying information or system control can be provided; and
a plurality of pushbutton momentary switches, each of the momentary switches provide at least one control signal to the module, wherein at least some of the plurality of pushbutton momentary switches cycle between the at least three different states of system control or identifying information to allow for each of the states of the system control to occur or the identifying information to be displayed via the cockpit display panel.

10. The system of claim 9, wherein the three different states comprise all, some or none, where some is an intermediate state between all and none.

11. The system of claim 9, wherein the three different states comprise at least one of (on, reset and off), or (on, auto and off).

12. The system of claim 9, wherein the plurality of momentary switches comprise any and any combination of a taxiway identifier switch, a map switch, a map orientation switch, a traffic switch, a traffic information switch, an autorange switch, a runway status switch, a taxi route switch, an airport operational information switch, and a multiple display mode switch.

13. The system of claim 9, wherein the three different states comprise three or more alternative mode states.

14. The system of claim 9, wherein the switches function differently on-ground than when in flight, or in different ground or flight phases.

15. A switching system utilized with an aircraft cockpit display comprising:
a module for providing images to a cockpit display; and
at least one momentary pushbutton switch to provide signals to the processing system, wherein the at least one momentary switch is capable of controlling three or more different states of information to the aircraft cockpit display.

16. The switching system of claim 15, wherein the three different states comprise all, some or none, where some is an intermediate state between all and none.

17. The switching system of claim 15, wherein the three different states comprise at least one of (on, reset and off) or (on, auto and off).

18. The switching system of claim 15, wherein the at least one momentary switch comprises a plurality of momentary switches.

19. The switching system of claim 18, wherein the plurality of momentary switches comprise any and any combination of a taxiway identifier switch, a map switch, a map orientation switch, a traffic switch, a traffic information switch, an autorange switch, a runway status switch, a taxi route switch, an airport operational information switch, and a multiple display mode switch.

20. A computer readable medium containing program instructions for displaying a specified area; the program instructions for:
processing data that determines a status of the specified area;
receiving identifying information about the specified area;
providing a criteria by which at least three different states of the identifying information or system control can be provided; and
utilizing at least one momentary switch to cycle between the at least three different states of identifying information to allow for each of the states of the identifying information to be displayed.

21. An aircraft, comprising:
a cockpit; and
a display system within the cockpit; the display system comprising a cockpit display panel capable of displaying images of an airport to a flight crew member; an airport moving map module that processes data that determines airport specific information, receives identifying information about the airport specific information and provides a criteria by which at least three different states of the identifying information or system control can be provided and a plurality of pushbutton momentary switches, each of the momentary switches provide at least one control signal to the module, wherein at least some of the plurality of pushbutton momentary switches cycle between the at least three different states of identifying information to allow for each of the states of the identifying information to be displayed via the cockpit display panel.

22. The aircraft of claim 21, wherein the three different states comprise all, some or none, where some is an intermediate state between all and none.

23. The aircraft of claim 21, wherein the three different states comprise at least one of (on, reset and off) or on, auto and off).

24. The aircraft of claim 21, wherein the at least one momentary switch comprises a plurality of momentary switches and wherein the plurality of momentary switches comprise any and any combination of a taxiway identifier switch, a map switch, a map orientation switch, a traffic switch, a traffic information switch, an autorange switch, a runway status switch, a taxi route switch, an airport operational information switch, and a multiple display mode switch.

25. The aircraft of claim 21, wherein the three different states comprises three alternative mode states.
